(19) United States
(12) Patent Application Publication
(10) Pub. No.: US 2018/0354768 A1
(43) Pub. Date: Dec. 13, 2018

(54) METHOD FOR FILLING PLASTIC BOTTLES PRODUCED BY STRETCH-BLOW-MOLDING

(71) Applicant: KHS GmbH, Dortmund (DE)

(72) Inventor: Olaf Muszinski, Kelkheim (DE)

(21) Appl. No.: 15/779,952

(22) PCT Filed: Nov. 22, 2016
(86) PCT No.: PCT/EP2016/078431

§ 371 Date: May 30, 2018

(30) Foreign Application Priority Data
Nov. 30, 2015 (DE) 10 2015 120 768.0

(51) Int. Cl. B67C 3/12; B29C 49/28; B29C 49/42; B67C 3/00

(52) U.S. Cl. CPC B67C 3/12; B29C 49/28; B29K 2067/003; B67C 3/007; B29C 49/4273

(57) ABSTRACT

A method that comprises receiving a plastic container that has been formed by stretch blow molding and immediately after having received the container, while the container is still hot from having been formed, filling the container with carbonated liquid. Filling the container with the carbonated liquid comprises setting an internal pressure of the container to be a first pressure and causing the internal pressure to change from the first pressure as a function of a variable. The variable is either an extent to which the container is filled or a container temperature.

### RELATED APPLICATIONS

This application is the national stage under 35 USC 371 of international application PCT/EP2016/078431, filed on Nov. 22, 2016, which claims the benefit of the Nov. 30, 2015 priority date of German application DE102015120768.0, the contents of which are herein incorporated by reference.

### FIELD OF INVENTION

The present invention relates to filling bottles, and in particular, to filling bottles that have recently been formed by stretch blow molding.

### BACKGROUND

In the bottling industry, it is known to form a PET bottle with a blow-molding machine and to fill that bottle after it has been formed.

The process of filling a bottle with a carbonated beverage typically includes subjecting the container's interior to high pressure. The pressure chosen is typically higher than the saturation pressure of the beverage with which the bottle is to be filled. The gas pressure is typically 4-7 bar depending on the dissolved carbon dioxide concentration and the temperature of the beverage. This pressure, among other things, prevents frothing.

After having been formed by a blow-molding machine, a PET bottle remains warm for some time. A warm PET bottle is quite flexible. As a result, elevated pressure within a warm PET could easily deform it. At best, this will result in an unsightly bottle that consumers will shy away from. But sometimes, the bottle's base deforms. This means the bottle cannot even stand up on its own. This impairs bottle-processing machinery that relies on the bottles being able to at least stand.

It is therefore useful to cool the bottles before filling them. For this reason, there exists a cooling segment between the stretch-blow molding machine and the filling machine. This cooling segment requires considerable space. In many cases, the cooling process itself consumes energy or requires consumption of some cooling medium.

### SUMMARY

An object of the invention is to provide a method that economically fills stretch-blow molded plastic bottles with carbonated beverages and does so with minimal spatial requirements and lower costs expenditure.

During bottling, two pressures come into play.

A first pressure is that at which the beverage is transferred into the bottle, i.e. the filling pressure of the beverage. The first pressure can arise in several ways. One source of the first pressure is the hydrostatic pressure of the beverage, i.e. that which is incurred by the arrangement and size of the product bottle above the filling machine and the geometric parameters. Another source of the first pressure is a pump. The pump injects the beverage at a defined pressure. A third source of the first pressure is a gas cushion, subjected to pressure, above the liquid level of the product bottle. In both cases, the first pressure can be set, adjusted, controlled, or regulated.

A second pressure is the internal pressure caused by gas in the bottle. It is this internal pressure that is significant to the subject matter of the invention.

In one aspect, the invention features filling hot plastic bottles with carbonated beverage immediately after they have been formed by stretch blow molding. This includes beginning the process with a first internal pressure and then transitioning to a second pressure during filling as either the extent to which the bottle has been filled changes or to the extent the bottle's temperature changes. This second pressure is preferably a reference pressure for filling the bottle with a particular carbonated beverage having a particular dissolved carbon-dioxide concentration. The first pressure is typically ambient pressure but it could also just be a pressure below the second pressure.

An advantage of this method is that when the bottle is still warm, and therefore when its walls are most susceptible to deformation from pressure, the pressure remains low enough to avoid deformation. But as the bottle fills, it cools down. Thus, its walls stiffen. This means that the walls become increasingly able to bear pressure. The filling pressure as a function of time is thus tuned to match the bottle's growing ability to sustain pressure as a function of time.

Another advantage is that as the bottle is filled, the beverage collects first on the base first. This cools the base area relatively quickly and thus stiffens it relatively quickly. This suppresses the risk of deforming the base region and thus crippling the bottle's ability to stand on its own. Once the base is safely cooled, it is safe to raise the pressure, thus suppressing the tendency of the beverage to froth during filling.

For most carbonated soft drinks, a reference pressure of 4.5 bar to 7 bar is adequate. The actual value will depend on the dissolved carbon-dioxide concentration, the ambient temperature, the solubility of carbon dioxide in the beverage, and the walls' and base's ability to sustain pressure.

Thus use of a multi-stage filling procedure in which filling begins with an initial pressure that rises to a higher pressure, such as the reference pressure, suppresses the risk of deformation that might occur when filling a bottle while it is still warm from having just been blow molded and results in greater reliability even when the beverage has a great deal of dissolved gas.

The transition between the initial pressure and a higher reference pressure can take different forms. In some practices, the transition is continuous, with no discrete steps. In others, it takes place in one or more discrete steps.

The method makes it possible to immediately fill a bottle just after it comes out of the blow-molding machine without having to wait for it to cool down. This makes avoids the need for a cooling segment between the blow-molding machine and the filling machine. Omitting a cooling segment saves space and avoids the costs of operation, as well as the need to handle the bottles at the cooling segment while they are still warm. This is not trivial because the bottles are warm and hence easily deformable. Omitting the cooling segment also reduces the risk of contamination. After all, bottles that travel along the cooling segment will not yet have been closed. Therefore, contaminants can easily fall inside through the open mouth.

Filling begins with sealing bottle against the filling-machine's opening to facilitate control over internal pressure. Such control is particularly important to suppress frothing during filling. Avoidance of frothing requires relatively high pressure, referred to as a “reference pressure.” This elevated reference pressure is usually between 5 and 8 bar and preferably between 4 and 7 bar. When sealed against the opening, the bottle's interior connects to a return-gas channel and to a compressed-gas source via a compressed-gas line. Controlling these lines provides a way to control internal pressure.

Some practices of the invention include closing the return-gas channel and disconnecting the compressed-gas source while beverage enters the container. As beverage fills the bottle, the internal pressure inevitably rises. This is because the volume left for gas constantly decreases as the beverage fills the bottle.

Some practices of the invention include leaving the return gas channel as beverage enters. In these practices, the internal pressure remains constant, at either ambient pressure or at whatever pressure it has been adjusted to.

Some practices of the invention include connecting the compressed-gas source to the interior. In these practices, it is possible to increase the internal pressure any desired pressure up to the maximum pressure of the compressed-gas source.

Controlling the internal pressure includes actuating control valves in the return-gas channel and in the compressed-gas line. The desired internal pressure depends at least in part on the dissolved carbon dioxide content in the beverage, the solubility of carbon dioxide, and the beverage's temperature. For example, some beverages, like champagne, froth easily. For such beverages, the internal pressure is made higher. On the other hand, if the beverage is not so prone to frothing, either because of low carbon dioxide concentration of high solubility, the internal pressure can be set lower.

During filling, the rising level of beverage in the container reduces the volume of the container that is available to hold gas. Isolating the bottle's interior causes pressure within this volume to rise as beverage fills the bottle. This effect is achieved by closing valves in both the return-gas channel and the compressed-gas line. Doing so will also trap any carbon dioxide that comes out of solution during frothing. This released carbon dioxide thus makes a small contribution to increasing the internal pressure.

Some practices include measuring the temperature at a point on the bottle, such as the base area. This temperature measurement provides a basis for controlling the internal pressure. As the temperature of the bottle falls, it becomes less prone to deformation under pressure. As such, it becomes possible to increase pressure without significant risk of deformation.

During filling, the beverage lands on the bottle's base and therefore begins cooling it right away. As soon as the temperature measurement indicates enough cooling, the internal pressure can safely be raised. This puts an end to frothing during filling. At this point, the return-gas channel can also be opened to permit escape of gas displaced by incoming beverage.

Instead of, or in addition to using temperature as a basis for controlling internal pressure, it is also possible to use the extent to which the container has been filled. Measurement of filling level can be carried out in many ways. A particularly simple way is to use an optical device.

Thus, in some practices, a particular extent of filling correlates with covering the bottle's base with beverage, which itself correlates with temperature. These practices include measuring the extent of filling and comparing that with some reference value, and then using that as a basis for triggering an increase in internal pressure.

It is also possible to use elapsed time as a basis for controlling internal pressure. Given the specific heat of the bottle's material and its thermal conductivity, as well as the rate at which cooling beverage enters and the temperature of the cooling beverage, it is possible to model the time required to cool the container to any temperature. This provides the basis for using elapsed time as a basis for controlling internal pressure.

Some practices include increasing the internal pressure when the filling level is high enough to ensure complete coverage of the base area with beverage. This reduces the likelihood of base-area deformation when raising the pressure. The low internal pressure prior to this point reduces the risk of deformation when the bottle is still warm from having been formed.

Other practices include those in which the initial internal pressure is no more than 2 bar. In some of these embodiments, the initial internal pressure is no more than 1.5 bar. In yet other embodiments, the initial internal pressure is 1 bar. In still other embodiments, the initial internal pressure is ambient pressure or atmospheric pressure. As a result, the bottle sustains only low-pressure forces when it is most vulnerable, namely at the start of the filling process when it is still quite warm.

For filling a container, it is useful to specify a reference pressure that depends on the concentration of dissolved carbon dioxide and the inherent solubility of carbon dioxide. Practices of the invention thus include increasing the internal pressure. This can be carried in many ways, examples of which include closing the return-gas channel and/or opening the compressed-gas channel.

During an initial phase, up to a predetermined filling level, the internal pressure rises slightly from ambient pressure. In a typical practice, this predetermined filling level is the level at which the beverage submerges the bottle's base. Two phenomena contribute to this rise in internal pressure. First, the rising fill level reduces the volume available for gas, thus raising its pressure. Second, as a result of frothing, carbon dioxide tends to come out if solution, thereby increasing the total quantity of gas.

During a subsequent phase, once the bottle has been adequately cooled, it becomes possible to increase pressure to suppress frothing. In a typical practice, this occurs after the predetermined filling level has been reached. Upon reaching this predetermined filling level, the internal pressure is raised to a second pressure, such as the reference pressure. Because the bottle has been cooled, its walls and base have become stiff enough to sustain the higher reference pressure without deformation, and in particular, without deformation of the base area. Some practices of the invention include opening the return-gas channel once the internal pressure has reached the reference pressure.

Some practices include continuously increasing the pressure by continuously introducing fluid. However, the machinery required to practice such a method is technically more elaborate.

Alternative practices feature increasing the internal pressure in stages rather than continuously. Such practices begin with holding the bottle's interior at ambient pressure followed by closing the return-gas channel. This raises the pressure slightly. The compressed-gas line is then opened, thus connecting the bottle's interior to a compressed gas source. This quickly raises internal pressure to the reference pressure.

In some practices, the reference pressure is between 3 bar and 8 bar. In others, it is between 4-7 bar. In yet others, it is between 5 bar and 6 bar. The particular choice depends at least in part on parameters of the beverage that is to be bottled.

In some practices, the filling method includes pressing the bottle against the filling valve at ambient pressure, and carrying out a slow partial filling in which the return-gas valve and the compressed-gas line are closed until the bottle has cooled enough to stabilize. With the bottle now having been stabilized, the internal pressure is raised towards the reference pressure and rapid filling begins. This is followed by a slow filling towards the end of the filling process, a calming phase, and a pressure relief phase, after which the bottle is released from the filling valve.

In some cases, the act of increasing the internal pressure affects the entry of beverage in the jet. If that is the case, it is possible to alternate between increasing the internal pressure and filling the container. This means stopping the filling procedure whenever internal pressure is to be increased. As an alternative, it is also possible to carry out a pressure-relief phase.

A disadvantage of the foregoing procedure is that it leads to slower filling with greater turbulence. In contrast, a filling process that is carried out continuously from beginning to end without interruption leads to more rapid filling of the bottle with less turbulence.

For most carbonated beverages, it is preferable for the reference pressure to be regulated to between 4-8 bar, in particular between 5 and 7 bar. To facilitate such regulation it is useful to selectively connect a compressed gas source is connected to the bottle interior. A suitable compressed gas is an inert gas, such as carbon dioxide or nitrogen. The choice of an inert gas avoids oxidation of the beverage.

Some practices include filling the bottle to a first filling-degree at a first pressure. The first pressure is either ambient pressure or a pressure that rises only slightly as a result of either compression of gas trapped in the bottle as beverage flows in or as a result of gas from the beverage coming out of solution as a result of frothing.

Such practices continue with filling the bottle to the desired fill level at a second pressure, which is preferably the reference pressure. Most of the filling occurs at this second pressure to avoid frothing.

Among the foregoing practices are those in which 2-30% of the bottle is filled at the first pressure, as well as those in which 5-20% of the bottle is filled at the first pressure. This ensures submersion of the base area.

Some practices of the invention include introducing pressurized beverage into the bottle. Others include introducing beverage using hydrostatic pressure to introduce the beverage. The use of hydrostatic pressure makes regulation easier.

Some practices vary the manner in which the liquid is introduced.

Among these are practices that include shaping the jet to form a fan so that a larger surface area can be cooled. Among these are practices in which the jet can be formed into a fan at the beginning of the filling process and then reformed into a cylinder as the filling process continues.

In some practices, beverage enters in a jet centered relative to the bottle's opening. However, in other practices, beverage enters by flowing along the walls of the bottle and gas exchange occurs at a port that is centered relative to the bottle's opening.

In another aspect, the invention features an apparatus for producing and filling plastic bottles, and in particular PET bottles. Such an apparatus includes a stretch-blow molding machine and a filling machine downstream of the stretch-blow molding machine. The filling machine is arranged directly next to the stretch-blow molding machine, i.e. in direct connection to it, such that there is no cooling segment between the stretch-blow molding machine and the filling machine. The filling machine is configured to cause bottles that have just come from the stretch-blow molding machine, and which are therefore still quite hot, to start filling with a first internal pressure and to increase the internal pressure in the course of filling to a second internal pressure. Preferably, the second internal pressure is the reference pressure.

An advantage of the apparatus is that that of filling bottles while they are still hot from just having been formed and to do so without deforming the bottles.

These and other features of the invention will be apparent from the following detailed description and the accompanying figures, in which:

### BRIEF DESCRIPTION OF THE FIGURES

FIG. 1 shows a device for producing and filling PET bottles;

FIG. 2 shows a detail from the filling machine from FIG. 1 for the gas-tight controlling of the pressure in the bottle interior during the filling;

FIG. 3 shows various possibilities for controlling the pressure during the filling of the bottle as a function of the extent to which the bottle has been filled, and

FIG. 4 shows three methods for controlling the pressure in the bottle as a function of elapsed time since the start of filling.

### DETAILED DESCRIPTION

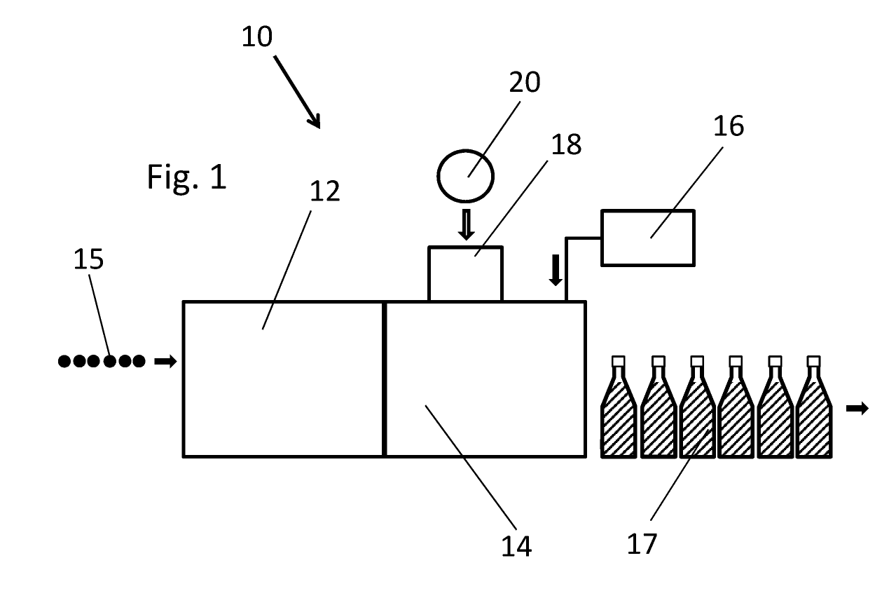

FIG. 1 shows a device 10 for producing and filling PET bottles.

The device 10 comprises a stretch blow-molding machine 12 and a filling machine 14 arranged directly thereafter. The blow-molding machine 12 connects directly to the filling machine 14 with no cooling segment arranged between them.

The blow-molding machine 12 receives bottle preforms 15 and blows them, while they are still hot, into bottles 25, such as bottles. In an alternative embodiment, the blow-molding machine 12 begins with PET pellets instead of preforms. Once the bottles 25 have been formed, the blow-molding machine 12 transfers them to the filling machine 14 directly downstream. The filling machine 14 then outputs filled bottles 17.

The filling machine 14 includes a beverage reservoir 16 from which it draws on a supply of beverage that is to be bottled. Examples of a beverage reservoir 16 include a tank and a delivery-line.

The filling machine 14 also includes a pressure-control device 18 that connects to a compressed-gas source 20. This permits the pressure within the bottle 25 to be controlled during filling thereof.

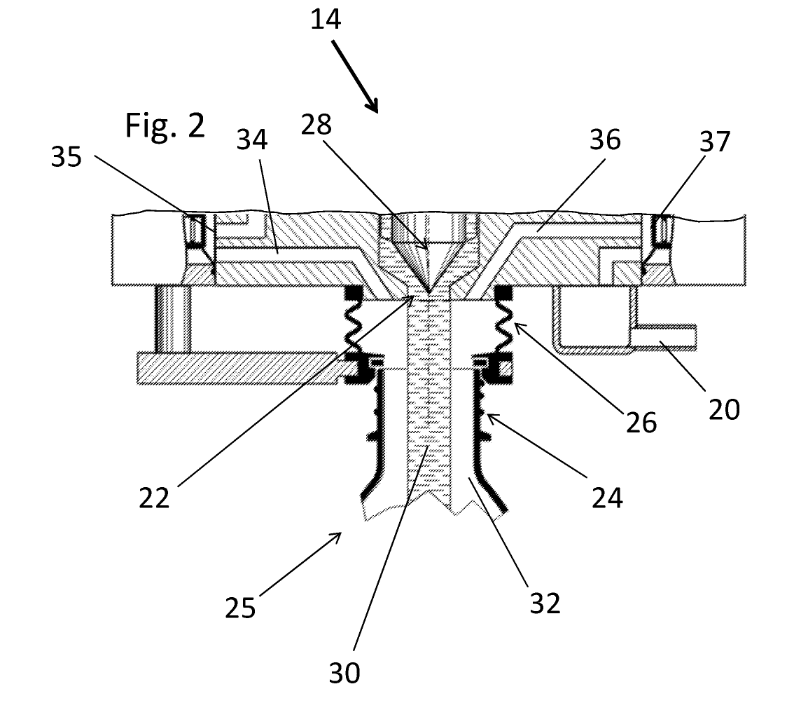

FIG. 2 shows the filling machine 14 with a sleeve 26 forming a gas-tight connection between the filling-machine's outlet 22 and an opening 24 of a bottle 25. In the illustrated embodiment, the filling valve 28 has been opened. As a result, a jet 30 of beverage flows past the filling valve 28 and into the bottle's interior 32. This displaces gas, referred to herein as the “return gas.” The return gas escapes through a return-gas channel 34 that connects the bottle's interior 32 to the beverage reservoir 16.

In some cases, it is also necessary to introduce compressed gas into the bottle 25. For this purpose, a compressed-gas line 36 connects the bottle's interior 32 to the compressed-gas source 20.

The optimal pressure in a bottle 25 during the filling process is generally not constant. It varies as a function of the extent to which the bottle 25 is filled. By regulating or controlling both the return gas channel 34 and the compressed gas line 36 during the filling process, it is possible to individually control the pressure in each bottle 25 to take into account different filling behaviors associated with different beverages, i.e. in particular of beverages with different carbon-dioxide concentrations.

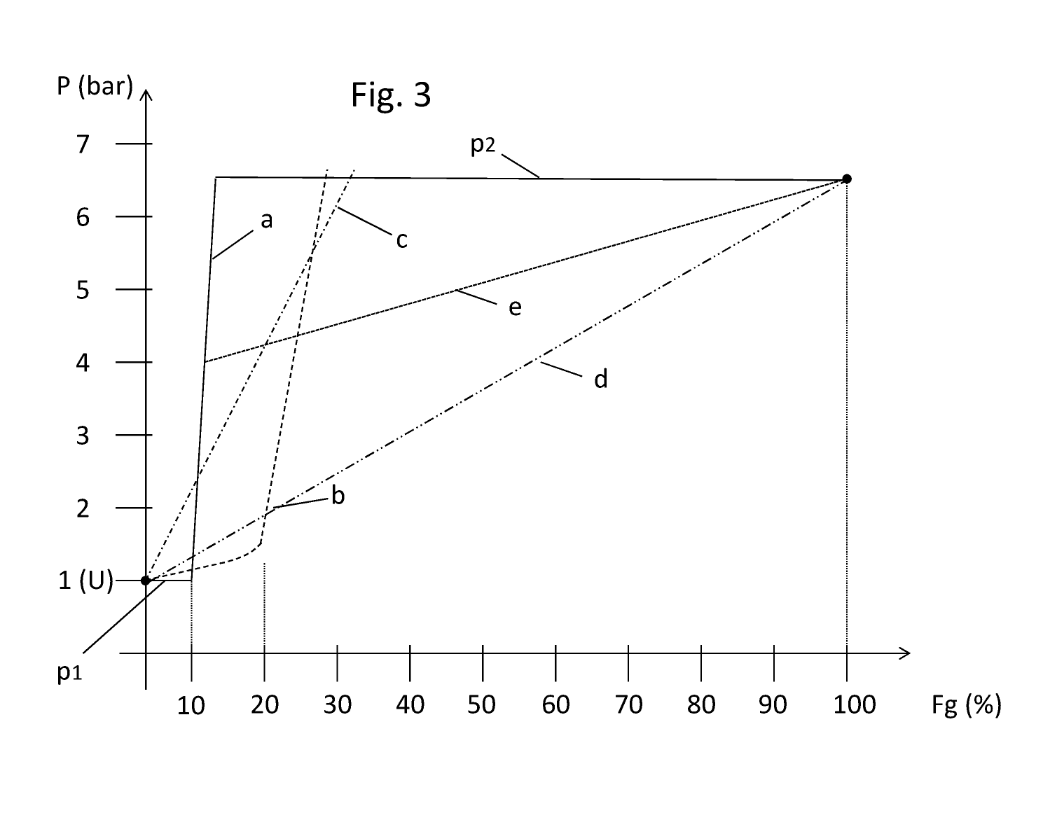

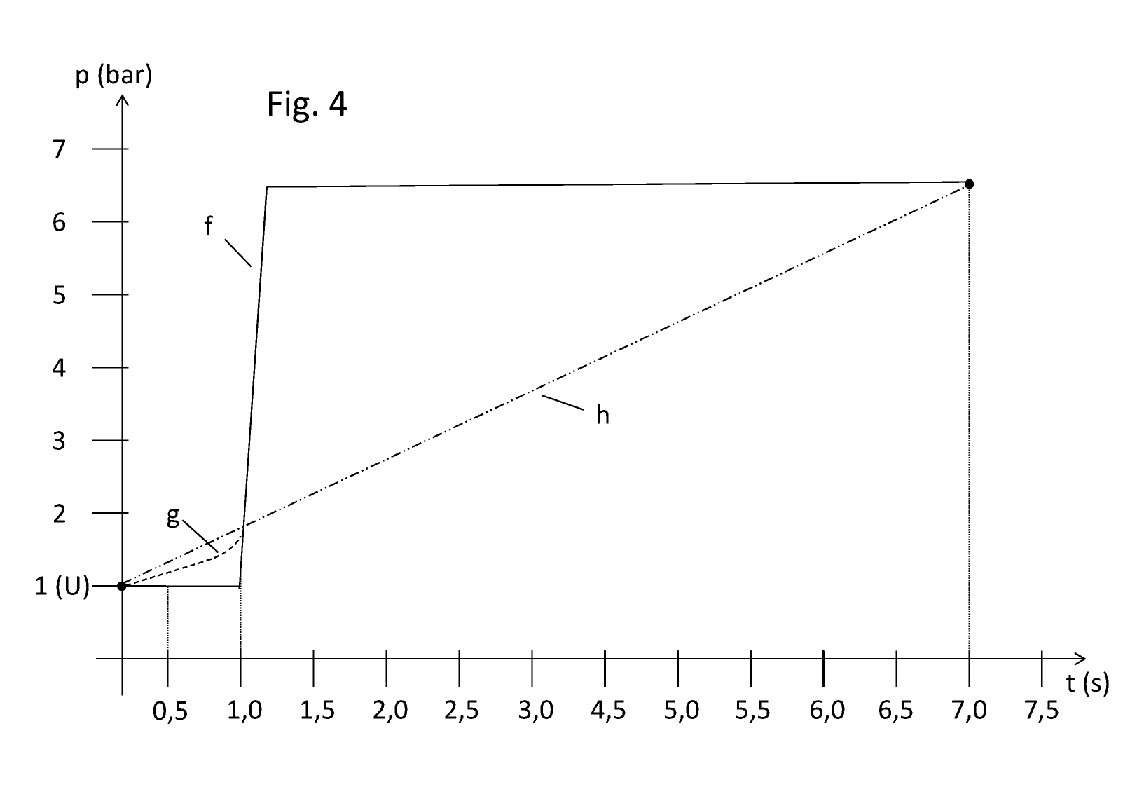

FIGS. 3 and 4 show trajectories of internal pressure as a function of different independent variables. In both figures, the internal pressure is along the vertical axis and the independent variable is along the horizontal axis. In FIG. 3, the independent variable is the extent to which the bottle is filled, expressed in percent. In FIG. 4, the independent variable is the elapsed time from the onset of the filling procedure. In all the examples from FIGS. 3 and 4, hydrostatic pressure provides the filling pressure of the beverage.

According to an exemplary filling curve a in FIG. 3, filling begins with opening the filling valve 28 and leaving the return-gas channel 34 open. As a result, when the jet 30 runs into the bottle 25, the displaced gas and any carbon dioxide that comes out of solution can escape through the return-gas channel 34. This configuration thus holds the pressure in the bottle's interior 32 at an initial pressure p1 of 1 bar, which is also the ambient pressure.

As soon as 10% of the bottle 25 has been filled, the return-gas channel 34 closes and the compressed-gas line 36 opens. This quickly raises pressure in the bottle 25 to a reference pressure p2, where it remains until the bottle 25 has been completely filled. In the illustrated example, the reference pressure p2 is 6.5 bar.

In a second filling curve b, the filling valve 28 opens such that the jet 30 runs into the bottle 25. However, instead of leaving the return-gas channel 34 open, it remains closed. This means that displaced gas cannot escape through the return-gas channel 34. As a result, the pressure rises. By the time the bottle 25 has been filled to 10% or 20%, the internal pressure will have reached about 1.4 bar. At that point, the compressed-gas line 36 opens. This sharply raises pressure up to 6.5 bar. Since gas does not move infinitely fast, the pressure rise is not instantaneous. For example, using typical filling equipment with a 500-milliliter bottle 25, this pressure rise can take about 500 milliseconds.

As shown in FIG. 2, a regulating valve 37 opens the compressed-gas line 36. Such a regulating valve 37 permits the temporal course of the pressure rise to be adjusted. For example, by partially closing the regulating valve 37, it is possible to slow the rise to the regulating pressure by 1 to 3 seconds.

In a third filling curve c, the filling process again begins at ambient pressure but with the return-gas channel 34 closed. The regulating valve 37 opens to admit compressed gas and does so in a way that causes the internal pressure to reach the reference pressure when the bottle 25 has been filled to 30%.

In a fourth filling curve d, the filling process again begins at ambient pressure but with the return-gas channel 34 closed. The regulating valve 37 opens to admit compressed gas and does so in a way that causes the internal pressure to reach the reference pressure when the bottle 25 has been filled to 100%.

An advantage of the fourth filling curve d is that no channels need to be opened or closed during the actual filling process. This method therefore avoids introducing any pressure transients. As a result, the pressure rises continuously.

According to a fifth filling curve e, filling begins with opening the filling valve 28 and leaving the return-gas channel 34. This holds the bottle's internal pressure at 1 bar. As a result, when the beverage jet 30 runs into the bottle 25, the displaced gas and any carbon dioxide that comes out of solution can escape. This maintains a constant 1 bar pressure.

Upon 10% of the bottle 25 having been filled, the return-gas channel 34 closes and the compressed-gas line 36 opens. This quickly raises pressure in the bottle 25 to an intermediate pressure of 4 bar.

The regulating valve 37 then opens to admit compressed gas. It does so in a way that causes the internal pressure to linearly increase until it reaches the reference pressure. This occurs when the bottle 25 has been filled to 100%.

In the examples shown in FIG. 4, bottle filling takes seven seconds. The time required to fill depends on the size of the bottle 25 and how fast beverage enters the bottle. For most practical applications, the time required to fill the bottle 25 is between three and twenty seconds.

A method that executes the sixth filling curve f begins with opening both the filling valve 28 and the return-gas channel 34 for one second to maintain the bottle's interior at ambient pressure. The method continues with opening the regulating valve 37, thus connecting the bottle's interior 32 to the compressed-gas source 20 via the compressed-gas line 36. This causes the internal pressure to rapidly rise to the reference pressure. In the illustrated example, the internal pressure rises to a reference pressure of 6.5 bar within about 0.2-0.5 seconds.

A method that executes the seventh filling curve g begins with opening both the filling valve 28 but keeping the return-gas channel 34 closed during the first second. As a result, the internal pressure rises during the first second from gas displaced by incoming beverage and by carbon dioxide that comes out of solution. The method continues with opening the regulating valve 37, thus connecting the bottle's interior 32 to the compressed-gas source 20 via the compressed-gas line 36. This causes the internal pressure to rapidly rise to the reference pressure. In the illustrated example, the internal pressure rises to a reference pressure of 6.5 bar within about 0.2-0.5 seconds.

A method that executes the eighth filling curve h proceeds by linearly increasing internal pressure over the course of the entire filling time, which in the illustrated embodiment lasts for seven seconds.

Having described the invention, and at least on preferred embodiment thereof, what is claimed as new and secured by Letters Patent is:

1-17. (canceled)

18. A method comprising receiving a plastic container that has been formed by stretch blow molding and, immediately after having received said container, while said container is still hot from having been formed, filling said container with carbonated liquid, wherein filling said container with said carbonated liquid comprises setting an internal pressure of said container to be a first pressure and causing said internal pressure to change from said first pressure as a function of a variable, wherein said variable is selected from the group consisting of an extent to which said container has been filled and a container temperature.

19. The method of claim 18, further comprising restraining carbon dioxide that leaves said carbonated liquid as a result of frothing from leaving said container.

20. The method of claim 18, further comprising measuring a temperature of said container, wherein causing said internal pressure to change comprises causing said internal pressure to change as a function of said measured temperature.

21. The method of claim 18, further comprising measuring a quantity of carbonated liquid that has been introduced into said container, wherein causing said internal pressure to change comprises causing said internal pressure to change as a function of said measured quantity.

22. The method of claim 18, further comprising measuring a filling level in said container, wherein causing said internal pressure to change comprises causing said internal pressure to change as a function of said measured filling level.

23. The method of claim 18, further wherein causing said internal pressure to change comprises causing said internal pressure to change as a function of filling time.

24. The method of claim 18, further comprising selecting said first pressure to be no greater than 2 bar.

25. The method of claim 18, further comprising selecting said first pressure to be no greater than halfway between said ambient pressure and twice said ambient pressure.

26. method of claim 18, further comprising selecting said first pressure to be ambient pressure.

27. The method of claim 18 further comprising setting a reference pressure, wherein said reference pressure is an internal pressure that is to exist in said container upon having completed filling of said container, wherein causing said internal pressure to change comprises keeping a return-gas channel closed until a predetermined filling level has been reached and, after said predetermined filling level has been reached, increasing said internal pressure to said reference pressure.

28. The method of claim 27, further comprising opening said return-gas channel after said internal pressure has reached said reference pressure.

29. The method of claim 18, wherein causing said internal pressure to change comprises causing said internal pressure to change in stages.

30. The method of claim 18, wherein causing said internal pressure to change comprises alternating between changing pressure and filling said container.

31. The method of claim 18, further comprising setting a reference pressure, wherein said reference pressure corresponds to an internal pressure that is to be present in said container upon having filled said container, wherein said reference pressure is between 5 bar and 7 bar.

32. The method of claim 18, wherein filling said container comprises causing said container to be filled at said first pressure during a first interval, wherein said first interval is an interval during which an extent to which said container has been filled is between 5% and 20%.

33. The method of claim 18, wherein filling said container comprises causing said container to be filled at said first pressure during a first interval, wherein said first interval is an interval during which an extent said container has been filled is between 2% and 30%.

34. The method of claim 18, wherein filling said container comprises causing said container to be filled at said first pressure during a first interval and causing said container to be filled at a second pressure during a second interval, wherein said first interval is an interval during which an extent to which said container has been filled is below a first value and wherein said second interval is an interval during which an extent to which said container has been filled is above said first value.

35. The method of claim 18, wherein filling said container comprises using hydrostatic pressure of said carbonated liquid to fill said container.

36. An apparatus configured for receiving a plastic container that has been formed by stretch blow molding, wherein said apparatus is configured to, immediately after having received said container, while said container is still hot from having been formed, carry out filling of said container with carbonated liquid, wherein filling of said container comprises setting an internal pressure of said container to be a first pressure and causing said internal pressure to rise as a function of a changing variable, wherein said changing variable is selected from the group consisting of an extent to which said container has been filled and an extent to which a container temperature has been decreased, said apparatus comprising a stretch blow molding machine and a filling machine downstream of said stretch blow molding machine and next to said filling machine, wherein no cooling segment separates said stretch blow molding machine from said filling machine, wherein, as a result, plastic containers proceed directly from said stretch molding machine to said filling machine.
